(19) United States
(12) Patent Application Publication
(10) Pub. No.: US 2022/0261684 A1
(43) Pub. Date: Aug. 18, 2022

(54) METHOD AND SYSTEM FOR OVERCOMING TAGGING SHORTAGE FOR MACHINE LEARNING PURPOSES

(71) Applicant: OTONOMO TECHNOLOGIES LTD., Even Yehuda (IL)

(72) Inventor: Asaf VALADARASKY, Kfar Saba (IL)

(73) Assignee: OTONOMO TECHNOLOGIES LTD., Even Yehuda (IL)

(21) Appl. No.: 17/175,827

(22) Filed: Feb. 15, 2021

(51) Int. Cl. G06N 20/00; G06K 9/62; G06F 21/62

(52) U.S. Cl. CPC G06N 20/00; G06F 21/6245; G06K 9/6256

(57) ABSTRACT

A method and a system for overcoming tagged automotive data shortage using machine learning. The system may be implemented over an online automotive data marketplace and may include: a data processing module implemented on a computer processor which receives a set of tagging functions and required automotive data features; a dataset generator implemented on said computer processor which creates custom training sets for a plurality of machine learning algorithms, without tagged data, based on processed automotive data; and a machine learning algorithm generator implemented on said computer processor which trains the machine learning algorithms using the custom training sets, to yield a trained model.

### FIELD OF THE INVENTION

The present invention relates generally to the field of data processing, and more particularly to processing of automotive data over a computer network.

### BACKGROUND OF THE INVENTION

Prior to the background of the invention being set forth, it may be helpful to provide definitions of certain terms that will be used hereinafter.

The term “connected vehicle” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform that enables a plurality of users (e.g. “data consumers”) to access and consume data. Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces may be used by businesses of all kinds, fleets, business and safety applications and many types of analysts.

The term General Data Protection Regulation (GDPR) as used herein is a regulation in the European Union (EU) law on protection and privacy for all individuals within the EU. The GDPR aims primarily to give control to individuals over their personal data and to simplify the regulatory environment for international business by unifying the regulation within the EU. Similar privacy legislations such as the California Consumer Privacy Act (CCPA) were enacted in other jurisdictions around the world.

The term “data anonymization” as used herein is defined as type of information sanitization whose intent is privacy protection. It is the process of either encrypting or removing personally identifiable information from data sets, so that the people and other entities whom the data describe remain anonymous.

Automotive data is being used in many ways both in anonymized and personal formats. An automotive data marketplace with access to multiple data provides may have data consumers with very different needs. Specifically, some data consumers may wish to use the automotive data for their own machine learning tasks.

The main challenge is that most machine learning algorithms require large amount of tagged data. However, tagged data could be unattainable or scarce for many tasks. This challenge is intensified when the tagged data is proprietary.

Several solutions for the tagged data shortage have been suggested in various domains. However, none of these solutions offer a practical manner to dealing with enormous amount of automotive data record that may be processed in an actual electronic automotive data marketplace.

### SUMMARY OF THE INVENTION

Some embodiments of the present invention overcome the aforementioned challenges. Embodiments of the present invention allow users (e.g. data consumers) to specify tagging “functions” which capture the behavior of tagged automotive data (e.g., if a car is parked overnight, it must be a home location). These functions enable the training of different machine learning algorithms without actual access to tagged data.

In accordance with some embodiments of the present invention, an online automotive data marketplace collects automotive data and stores it securely with accordance to data privacy regulations.

In accordance with some embodiments of the present invention, any data consumer may provide a set of data tagging functions as well as automotive data features they require from the automotive data marketplace. Given the set of function and required data features, the online automotive data marketplace creates custom training sets for a plurality of machine learning algorithms, without the need of tagged data.

In accordance with some embodiments of the present invention the online automotive data marketplace then trains the algorithms, thereby providing a final trained model to the data consumer. Optionally, the data consumer may validate the resulting algorithm using their own tagged datasets. If the model performs badly, the data consumer may provide feedback to the online automotive data marketplace that will trigger a revision process of the resulting algorithms.

Advantageously, some embodiments of the present invention enable using un-tagged data of any type and kind and open up data sources that were not previously accessible for harvesting data features.

Further advantages of the present invention are set forth in detail in the following description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system in accordance with embodiments of the present invention;

FIG. 2 is a high-level flowchart illustrating a computer-implemented method in accordance with embodiments of the present invention;

FIG. 3 is a high-level flowchart illustrating an aspect in accordance with embodiments of the present invention; and

FIG. 4 is a high-level flowchart illustrating another aspect in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing”, “calculating”, “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

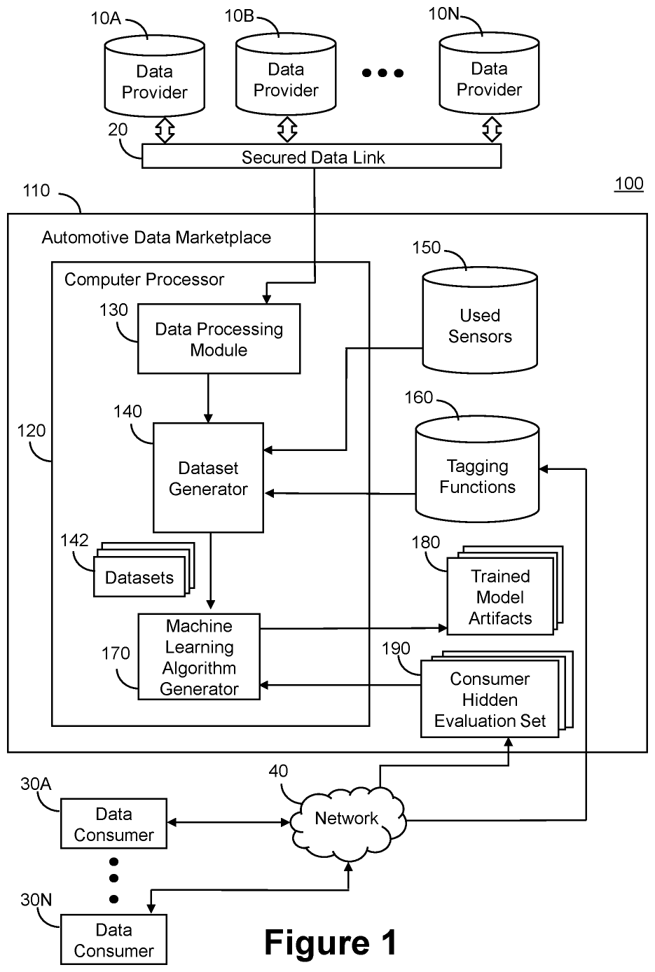

FIG. 1 is a block diagram illustrating non-limiting exemplary architecture of a regulated automotive data distribution network 100 in accordance with embodiments of the present invention. Automotive data distribution network 100 comprises an online automotive data marketplace 110 which may, in preferable embodiments, be compliant with privacy regulations such as GDPR and CCPA.

In accordance with some embodiments of the present invention automotive data marketplace 110 may be connected, for example via secured wireless data link 20, to a plurality of automotive data sources 10A-10N (e.g. “data providers”).

As will be appreciated by those skilled in the art, each automotive data source 10A-10N may be a connected vehicle (having, for example, one or more sensing devices), road-bound infrastructure (e.g., a traffic camera, weather station, or the like) and/or a remote data repository (e.g., a third-party database, such as one comprising a list of vehicle models having certain vehicle parts). Automotive data marketplace 110 may be further connected, for example via wireless connection to network 40, with one or more data consumers 30A-30N. A data processing module 130 implemented by a computer processor 120 may also be included within automotive data marketplace 110. Data processing module 130 may be configured, when operated by computer processor 120, to anonymize, and preferably also normalize, automotive data obtained from automotive data sources 10A-10N and, optionally, store said anonymized automotive data within a processed automotive data store (not shown here).

In accordance with some embodiments of the present invention, automotive data marketplace 110 further includes dataset generator 140 implemented on a computer processor which receives a set of tagging functions 160 and required automotive data features and creates custom training sets 142 for a plurality of machine learning algorithms, without tagged data, based on processed automotive data.

Automotive data marketplace 110 further includes machine learning algorithm generator 170 implemented on said computer processor which trains the machine learning algorithms using the custom training sets, to yield a trained model.

In accordance with some embodiments of the present invention, the set of tagging functions and the required data features are provided by a data consumer and a database indicting the used sensors 150 may be used.

In accordance with some embodiments of the present invention the system includes a consumer hidden evaluation set configured to validate the machine learning algorithms over the computer processor.

In accordance with some embodiments of the present invention, the machine learning algorithm generator receives feedback from the data consumer responsive to the validating of the machine learning algorithms, and repeats the training of the machine learning algorithms, considering said feedback, to yield an improved trained model.

In accordance with some embodiments of the present invention, the processed automotive data complies with privacy regulations.

In accordance with some embodiments of the present invention, the tagging functions contextually associate automotive data features with automotive data use cases.

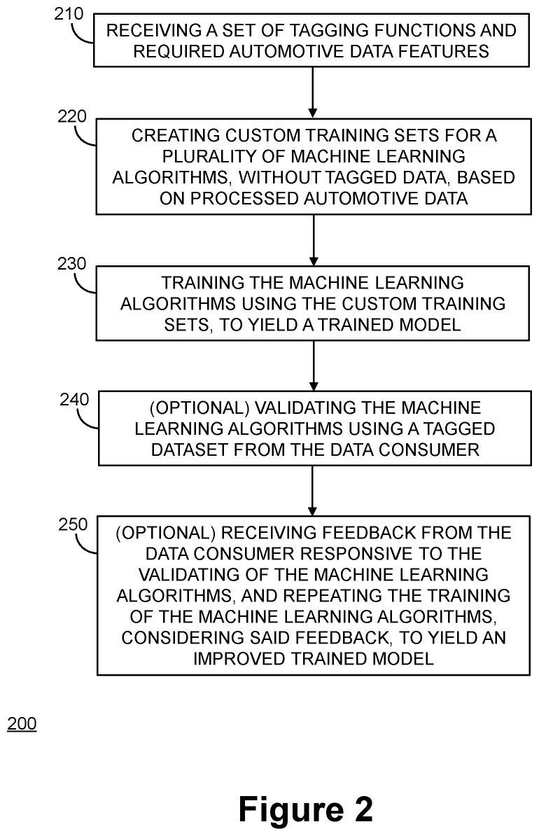

FIG. 2 is a high-level flowchart illustrating a non-limiting exemplary method 200 in accordance with embodiments of the present invention. Method 200 of overcoming tagged automotive data shortage using machine learning may include the following steps: receiving a set of tagging functions and required automotive data features 210; creating custom training sets for a plurality of machine learning algorithms, without tagged data, based on processed automotive data 220; and training the machine learning algorithms using the custom training sets, to yield a trained model 230.

According to some embodiments of the present invention method 200 may further include the step of validating the machine learning algorithms using a tagged dataset from the data consumer 240.

According to some embodiments of the present invention method 200 may further include the step of receiving feedback from the data consumer responsive to the validating of the machine learning algorithms, and repeating the training of the machine learning algorithms, considering said feedback, to yield an improved trained model 250.

It should be noted that method 200 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

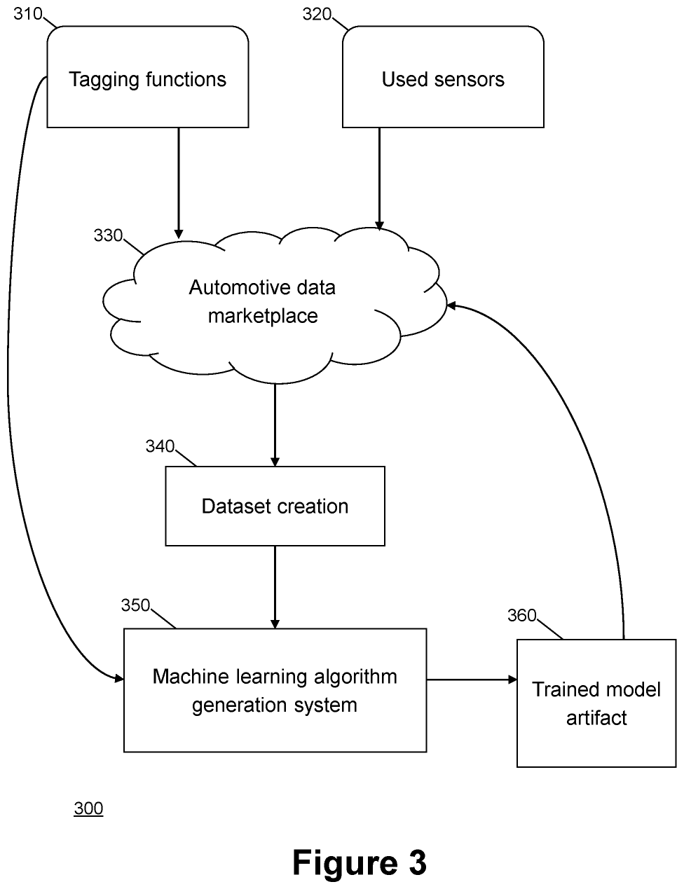

FIG. 3 is a high-level flowchart illustrating an aspect in accordance with embodiments of the present invention. Data flow 300 may be implemented over the architecture of system 100 as detailed above in FIG. 1. Tagging functions 310 as suggested by and for data consumers and data provides as well as used sensors 320 of the connected vehicles are provided as inputs to automotive data marketplace 330 which manages a dataset creation 340 which in turn uses a machine learning algorithm generation system 350 which generates a trained model artifact 360 which is used in to automotive data marketplace 330.

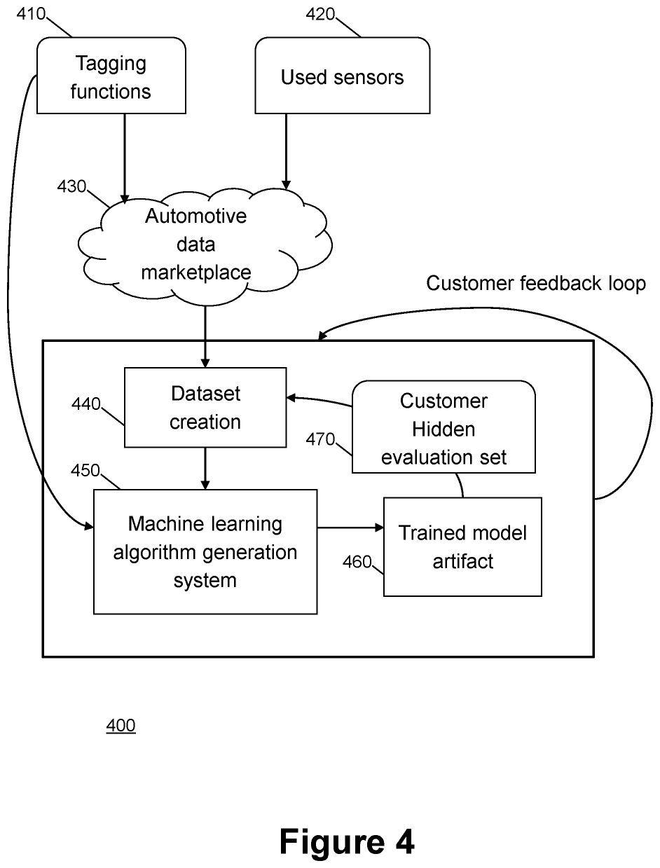

FIG. 4 is a high-level flowchart illustrating another aspect in accordance with embodiments of the present invention. Data flow 400 may be implemented over the architecture of system 100 as detailed above in FIG. 1. Tagging functions 410 as suggested by and for data consumers and data provides as well as used sensors 420 of the connected vehicles are provided as inputs to automotive data marketplace 430 which manages a dataset creation 440 which in turn uses a machine learning algorithm generation system 450 which also received tagging functions 410 directly, to generate a trained model artifact 460 which is applied to a customer hidden evaluation set 470 which is used in dataset creation 440 thus implementing a customer feedback loop that further improves the trained model artifact used by automotive data marketplace 430.

Advantageously since automotive data marketplace 430 is capable of collecting automotive data been and storing it securely with accordance to data privacy regulations (e.g. GDPR and CCPA), embodiments of the present invention can offer customers (e.g. data providers and data consumers) the ability to provide a set of tagging functions, and required data features needed for their operations. Given the set of functions, and features, automotive data marketplace 430 creates a custom training set for various machine learning algorithms, without the need for tagged data.

Further advantageously, automotive data marketplace 430 then may train these algorithms to provide a final trained model for the customers. The customers can then validate the resulting algorithm using their own tagged data set (if it exists). If the trained model performs badly, the customer may provide feedback to our system which may trigger the process again based on his feedback.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of overcoming tagged automotive data shortage, using machine learning, the method comprising:
receiving a set of tagging functions and required automotive data features;
using machine learning algorithms capable of operating without tagged data based on processed automotive data, to create custom training sets; and
training a supervised model using the custom training sets, to yield a trained model.

2. The method according to claim 1, wherein the set of tagging functions and the required data features are provided by a data consumer.

3. The method according to claim 2, further comprising validating the machine learning algorithms using a tagged dataset from the data consumer.

4. The method according to claim 3, further comprising receiving feedback from the data consumer responsive to the validating of the machine learning algorithms, and repeating the training of the machine learning algorithms, considering said feedback, to yield an improved trained model.

5. The method according to claim 1, wherein the processed automotive data complies with privacy regulations.

6. The method according to claim 1, wherein the tagging functions contextually associate automotive data features with automotive data use cases.

7. A system for overcoming tagged automotive data shortage using machine learning, the system comprising:
a data processing module implemented on a computer processor which collects automotive data from data providers and yields processed automotive data;
a dataset generator implemented on said computer processor which received receives a set of tagging functions and required automotive data features and creates custom training sets for a plurality of machine learning algorithms, without tagged data, based on the processed automotive data; and
a machine learning algorithm generator implemented on said computer processor which trains the machine learning algorithms using the custom training sets, to yield a trained model.

8. The system according to claim 1, wherein the set of tagging functions and the required data features are provided by a data consumer.

9. The system according to claim 8, further comprising a consumer hidden evaluation set configured to validate the machine learning algorithms over said computer processor.

10. The system according to claim 9, further wherein said machine learning algorithm generator receives feedback from the data consumer responsive to the validating of the machine learning algorithms, and repeats the training of the machine learning algorithms, considering said feedback, to yield an improved trained model.

11. The system according to claim 7, wherein the processed automotive data complies with privacy regulations.

12. The system according to claim 7, wherein the tagging functions contextually associate automotive data features with automotive data use cases.

13. A non-transitory computer readable storage medium for overcoming tagged automotive data shortage using machine learning, the computer readable storage medium comprising a set of instructions that when executed cause at least one computer processor to:
receive a set of tagging functions and required automotive data features;
create custom training sets for a plurality of machine learning algorithms, without tagged data, based on processed automotive data; and
train the machine learning algorithms using the custom training sets, to yield a trained model.

14. The non-transitory computer readable storage medium according to claim 13, wherein the set of tagging functions and the required data features are provided by a data consumer.

15. The non-transitory computer readable storage medium according to claim 14, further comprising computer readable storage medium comprising a set of instructions that when executed cause the at least one computer processor to validate the machine learning algorithms using a tagged dataset from the data consumer.

16. The non-transitory computer readable storage medium according to claim 15, further comprising computer readable storage medium comprising a set of instructions that when executed cause the at least one computer processor to receive feedback from the data consumer responsive to the validating of the machine learning algorithms, and repeating the training of the machine learning algorithms, considering said feedback, to yield an improved trained model.

17. The non-transitory computer readable storage medium according to claim 13, wherein the processed automotive data complies with privacy regulations.

18. The non-transitory computer readable storage medium according to claim 13, wherein the tagging functions contextually associate automotive data features with automotive data use cases.
